(19) United States
(12) Patent Application Publication
(10) Pub. No.: US 2026/0093527 A1
(43) Pub. Date: Apr. 2, 2026

(54) SCHEDULER FOR RECONFIGURABLE ACCELERATOR

(71) Applicant: Samsung Electronics Co., Ltd., Suwon-si (KR)

(72) Inventors: Dong-hyeon PARK, Suwon-si (KR); Hyungwoo LEE, Suwon-si (KR)

(73) Assignee: Samsung Electronics Co., Ltd., Suwon-si (KR)

(21) Appl. No.: 19/270,767

(22) Filed: Jul. 16, 2025

(30) Foreign Application Priority Data
Sep. 30, 2024 (KR) 10-2024-0133237

(51) Int. Cl. G06F 9/48; G06F 9/50

(52) U.S. Cl. CPC G06F 9/4881; G06F 9/485; G06F 9/5033; G06F 9/5044

(57) ABSTRACT

A method of scheduling tasks includes: monitoring an accelerator to determine a resource state thereof; in response to receiving a first task from a processor among processors, determining that the first task is dispatchable for execution by the reconfigurable accelerator based on the resource state; in response to receiving a second task from any of the processors, determining that the second task is not dispatchable for execution by the accelerator based on the resource state; based on the first task being determined to be dispatchable, dispatching the first task to the accelerator for execution thereby; based on the second task being determined to be not dispatchable, adding the second task to a queue ordering tasks to be executed by the reconfigurable accelerator; and based on a change in the resource state, according to the ordering, dispatching a task in the queue to the accelerator.

### CROSS-REFERENCE TO RELATED APPLICATIONS

This application claims the benefit under 35 USC § 119(a) of Korean Patent Application No. 10-2024-0133237, filed on Sep. 30, 2024, in the Korean Intellectual Property Office, the entire disclosure of which is incorporated herein by reference for all purposes.

### BACKGROUND

### 1. Field

The following description relates to a scheduler for a reconfigurable accelerator and a method of operating the scheduler.

### 2. Description of Related Art

A coarse-grained reconfigurable array (CGRA) accelerator is a type of hardware accelerator that improves the performance of a computing system. Unlike a general-purpose processor like a central processing unit (CPU) or a graphics processing unit (GPU) that processes all operations, the CGRA accelerator has a hardware structure designed to process a particular task quickly.

A CGRA may be reconfigured into large-scale operation units, may have optimized performance for a variety of algorithms, and may process multiple tasks simultaneously by using multiple operation units in parallel.

CGRA accelerators are primarily designed to deliver high performance in particular areas such as image processing, signal processing, and artificial intelligence model inference tasks.

A CGRA has the advantage of being usable as a general-purpose accelerator since the CGRA has the form of a processing element (PE) array that is individually operable, may change an operation to be performed on each PE, and may change connection states of inputs and outputs (inter-PE connections) according to predetermined configuration information. However, in order to have an effect of acceleration, it may be necessary for the configuration information to be properly defined in advance to fit the current tasks being processed by the CGRA.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of scheduling tasks performed by a scheduler includes: monitoring a reconfigurable accelerator to determine a resource state of the reconfigurable accelerator; in response to a first task being received from a processor among processors sharing the reconfigurable accelerator, determining that the first task is dispatchable for execution by the reconfigurable accelerator based on the resource state; in response to a second task being received from any of the processors sharing the reconfigurable accelerator, determining that the second task is not dispatchable for execution by the reconfigurable accelerator based on the resource state; based on the first task being determined to be dispatchable, dispatching the first task to the reconfigurable accelerator for execution thereby; based on the second task being determined to be not dispatchable, adding the second task to a queue used to manage an order of tasks to be executed by the reconfigurable accelerator; and based on a change in the resource state, according to the order, dispatching a task in the queue to the reconfigurable accelerator.

The monitoring may include receiving an availability state of processing hardware and memory of the reconfigurable accelerator at predetermined time intervals.

The determining that the first task is dispatchable may include comparing available memory and processing-hardware capacity of the reconfigurable accelerator with a data size and processing-hardware requirement of the first task.

The dispatching of the first task to the reconfigurable accelerator may include: instructing a processor controller to generate a bitstream to be transmitted to the reconfigurable accelerator; and in response to the bitstream being transmitted to the reconfigurable accelerator, operation of the processor processing the task thereon is stopped.

The determining that the second task is not dispatchable may be based on determining that either available memory of the reconfigurable processor does not satisfy a data size of the second task or that processing-hardware capacity of the reconfigurable accelerator does not satisfy a processing-hardware requirement of the second task.

The adding of the second task to the queue may include: determining that a third task represented in the queue has a data pointer corresponding to a data pointer of the second task, and based thereon adding the second task in a position of the queue that is set relative to a position of the third task in the queue.

The adding of the second task to the queue may include: determining that a third task represented in the queue has a hardware configuration that overlaps with a hardware configuration of the second task, and based thereon adding the second task in a position of the queue that is set relative to a position of the third task in the queue.

The method may further include: receiving, from any of the processors, an execution completion signal corresponding to a third task; and deleting the third task from the queue based on the execution completion signal.

The method may further include: during execution of the reconfigurable accelerator, based on an available processing-hardware capacity of the resource state space being confirmed, reconfiguring processing hardware of the reconfigurable accelerator to execute a next task in the queue according to the order.

The method may further include: dispatching a third task included in the queue to the reconfigurable accelerator according to the order and based on a change in the resource state.

The adding of the second task to the queue may include: in response to an age of the second task in the queue exceeding a threshold, adjusting processing priority of the second task in the queue.

The reconfigurable accelerator may be a coarse-grained reconfigurable array (CGRA) accelerator.

A non-transitory computer-readable storage medium stores instructions that, when executed by a processor, cause the processor to perform any of the methods.

In another general aspect, a scheduler includes: one or more processors; and a memory storing instructions that when executed by the one or more processors cause the scheduler to: monitor a reconfigurable accelerator to determine a resource state of the reconfigurable accelerator; in response to a first task being received from a processor among processors sharing the reconfigurable accelerator, determine that the first task is dispatchable for execution by the reconfigurable accelerator based on the resource state; in response to a second task being received from any of the processors sharing the reconfigurable accelerator, determine that the second task is not dispatchable for execution by the reconfigurable accelerator based on the resource state; based on the first task being determined to be dispatchable, dispatch the first task to the reconfigurable accelerator; based on the second task being determined to be not dispatchable, add the second task to a queue used to manage an order of tasks to be executed by the reconfigurable accelerator; and based on a change in the resource state, according to the order, dispatch a task included in the queue to the reconfigurable accelerator.

The monitoring may include receiving an availability state of processing hardware and memory of the reconfigurable accelerator at predetermined time intervals.

The determining that the first task is dispatchable may include comparing available memory and processing-hardware capacity of the reconfigurable accelerator with a data size and processing-hardware requirement of the first task.

The dispatching of the first task to the reconfigurable accelerator may include: instructing a processor controller to generate a bitstream to be transmitted to the reconfigurable accelerator; and in response to the bitstream being transmitted to the reconfigurable accelerator, operation of the processor processing the task is stopped.

The determining that the second task is not dispatchable may be based on determining that either available memory of the reconfigurable processor does not satisfy a data size of the second task or that processing-hardware capacity of the reconfigurable accelerator does not satisfy a processing-hardware requirement of the second task.

The adding of the second task to the queue may include: determining that a third task represented in the queue has a data pointer corresponding to a data pointer of the second task, and based thereon adding the second task in a position of the queue that is set relative to a position of the third task in the queue.

The adding of the second task to the queue may include: determining that a third task represented in the queue has a hardware configuration that overlaps with a hardware configuration of the second task, and based thereon adding the second task in a position of the queue that is set relative to a position of the third task in the queue.

The scheduler may be configured to: receive, from any of the processors, an execution completion signal corresponding to a third task; and delete the third task from the queue based on the execution completion signal.

During execution of the reconfigurable accelerator, based on an available processing-hardware capacity of the resource estate space being confirmed, the processing hardware of the reconfigurable accelerator may be reconfigured to execute a next task in the queue according to the order.

Dispatching a third task included in the queue to the reconfigurable accelerator according to the order may be based on a change in the resource state.

The adding of the second task to the queue may include: in response to an age of the second task in the queue exceeding a threshold, adjusting processing priority of the second task in the queue.

In another general aspect, a method, includes: receiving, by an accelerator device, tasks executing on cores and transferred to the accelerator by the cores, wherein the cores analyze the tasks to select the tasks for transfer to the accelerator device, and each received task includes a task description specifying values of respective attributes of the task; managing a first-in-first-out (FIFO) task queue by the accelerator device, the managing including receiving the tasks and adding entries to the task queue that respectively represent the received tasks and that include the respective task descriptions of the tasks, wherein each time a new entry for a new task and its task description are added to the queue: it is determined whether at least a portion of the task description of the new task matches a corresponding portion of the task description of any entry in the task queue; when it is determined that at least a portion of the task description of the new task matches a corresponding portion of the task description of any entry in the task queue, the new entry for the task is added at a position in the task queue that corresponds to the position in the task queue of the entry with the matching task description; when it is determined that at least a portion of the task description of the new task does not match a corresponding portion of the task description of any entry in the task queue, the new entry for the task is added to the end of the task queue.

Each task description may describe, about its corresponding task, a data size requirement of the corresponding task, a processing-hardware requirement of the corresponding task, and a location of data used by the corresponding task.

The accelerator device may have reconfigurable processing elements (PEs), and each task description may describe, about its corresponding task, a processing-hardware requirement of the corresponding task, and while a first task is being executed by the accelerator device, based on monitoring a state of unallocated PEs of the accelerator device, and based on the processing-hardware requirement of a second task that is being dequeued from the task queue for execution by the accelerator device: configuring some of the unallocated PEs for use by the second task while the first task is executing and before the second task begins executing.

Other features and aspects will be apparent from the following detailed description, the drawings, and the claims.

### BRIEF DESCRIPTION OF THE DRAWINGS

FIG. 1 illustrates an example of a structure utilizing a coarse-grained reconfigurable array (CGRA), according to one or more embodiments.

FIG. 2 illustrates an example of a structure in which a scheduler is connected with multiple cores, according to one or more embodiments.

FIG. 3 illustrates an example of a queue for recording a schedule, according to one or more embodiments.

FIG. 4 illustrates an example of a scheduling method of a scheduler, according to one or more embodiments.

FIG. 5 illustrates an example of an operation of a scheduler, according to one or more embodiments.

FIGS. 6A and 6B illustrate an example of a method of scheduling by matching tasks, according to one or more embodiments.

FIG. 7 illustrates an example of an operation of a CGRA by general first in, first out (FIFO) scheduling, according to one or more embodiments.

FIG. 8 illustrates an example of a method of using a resource for reconfiguration, according to one or more embodiments.

FIG. 9 illustrates an example of a method of executing a task having duplicate data, according to one or more embodiments.

FIG. 10 illustrates an example of loading data using information of a queue, according to one or more embodiments.

FIG. 11 illustrates an example of a scheduler, according to one or more embodiments.

FIG. 12 illustrates an example of a platform for sharing an accelerator, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

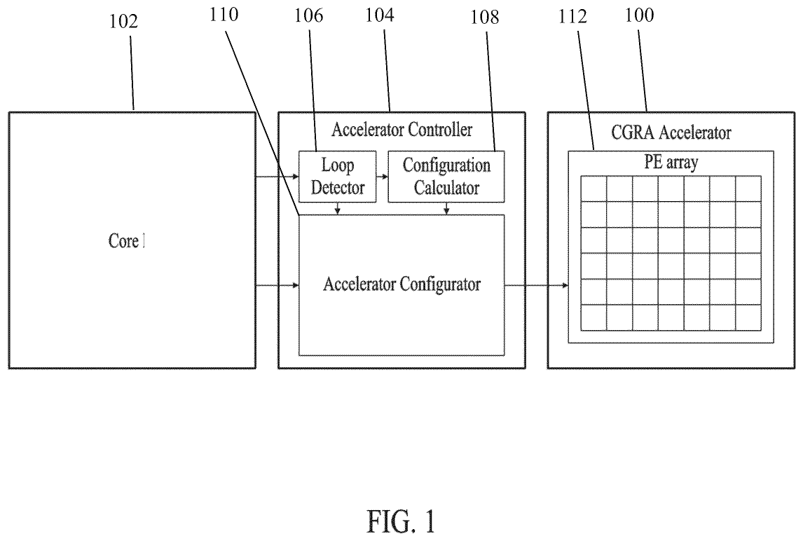

FIG. 1 illustrates an example of a structure utilizing a coarse-grained reconfigurable array (CGRA), according to one or more embodiments.

Referring to FIG. 1, as an example of utilizing a CGRA 100, a loop, which is a combination of repetitive instructions that are tightly coupled with a processor core 102 and which may be accelerated by utilizing the CGRA 100, may be detected. Based on the detection, connections of processing element (PE) arrays may be calculated and set to form a graph, and the connections may be calculated based on target instructions. A CPU using the accelerator 100 may include one or more CPU cores, including the core 102.

The structure may include the core 102, an accelerator controller 104, and the accelerator (CGRA) 100. The accelerator controller 104 may monitor instructions of the core 102, and when the accelerator controller 104 detects a pattern of instructions that are determined to be suitable to accelerate, the accelerator controller may calculate a new hardware configuration to run the instructions on the CGRA 100 and may apply the new configuration to the CGRA 100 to perform operations. For example, the accelerator controller 104 may include a loop detector 106, which may detect various patterns of instructions that are loops. The loop detector 106 may inform a configuration calculator 108 about a detected pattern of instructions (a loop), and the configuration calculator 108 may generate a corresponding new configuration (e.g., a PE graph configuration) that is provided to an accelerator configurator 110, which configures a PE array 112, for example by forming inter-PE connections corresponding to the PE graph configuration.

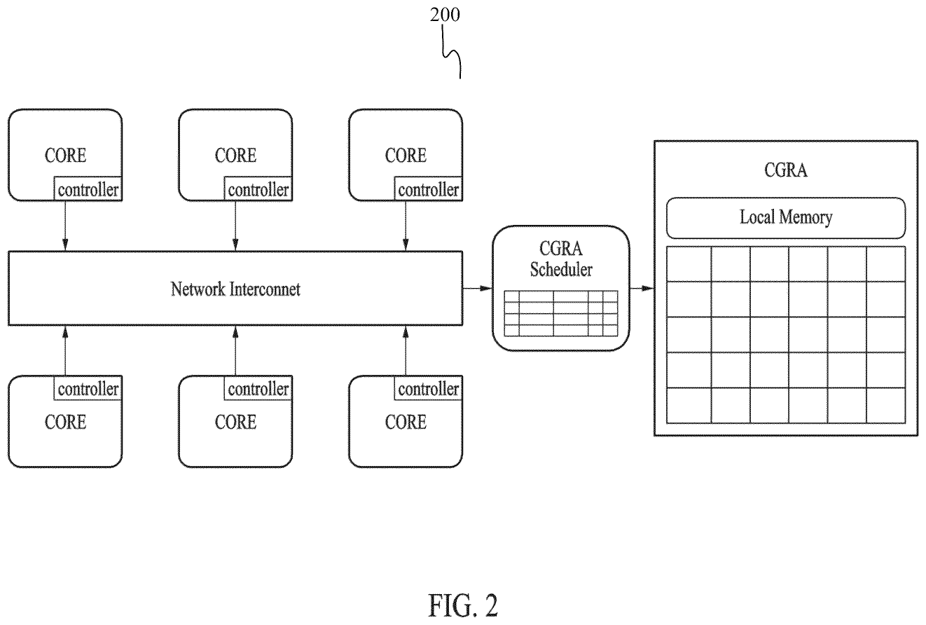

FIG. 2 illustrates an example of a structure in which a scheduler is connected with multiple cores, according to one or more embodiments.

In a situation where multiple processors or cores share a single accelerator, a scheduler for managing and dispatching, on the accelerator, tasks requested by the processors/cores may be necessary. This is usually implemented as a simple first in, first out (FIFO) queue. However, in the case of simple/strict FIFO-type scheduling, a CGRA, which may utilize resources in parallel, may not be utilized efficiently. An improved FIFO ordering may be used, where tasks are generally FIFO-scheduled (e.g., as a default scheduling action), but can have their scheduling priority (order in an working/execution queue of the accelerator) changed under various conditions, as described below.

As shown in FIG. 2, in a multi-core architecture 200 in which are arranged multiple processor cores, each including an accelerator controller for using a reconfigurable accelerators, a scheduling method of reusing an already arranged configuration for tasks of different cores with overlapping hardware configurations or overlapping data is described.

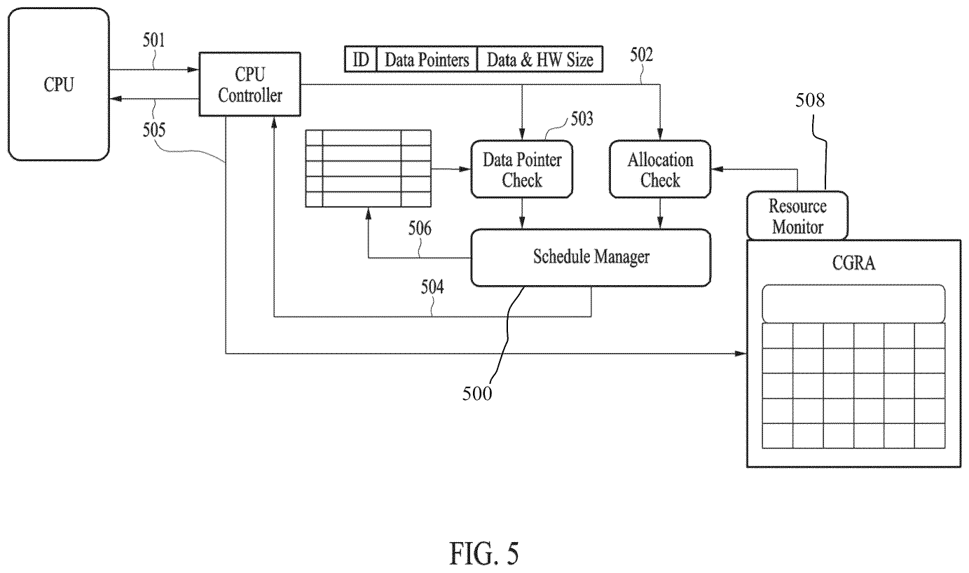

Resources of a system may be efficiently managed by utilizing a variety of information continuously recorded by a resource monitor of the CGRA (e.g., resource monitor 508 shown in FIG. 5). The resource monitor may track memory usage of the CGRA and real-time usage of hardware components and may provide this information to a scheduler (e.g., the scheduler 500 shown in FIG. 5). Based on this information, the scheduler may determine a current state of the CGRA.

Accordingly, the scheduler may execute tasks by appropriately assessing and allocating available resources within the CGRA. For example, the scheduler may determine whether a newly transmitted task may be executed based on current hardware usage and a current memory state as determined by the resource monitor.

When managing tasks comprehensively, the scheduler may increase CGRA utilization by grouping and closely scheduling tasks with similar properties, based on a hardware combination required by each task and data commonality between tasks, thereby reusing hardware and data of the CGRA by increasing sharing of same for grouped tasks.

The scheduler may manage a schedule by adding an entry representing a newly transmitted task to a queue when immediate dispatching (i.e., beginning to execute) of the newly transmitted task is not possible due to current availability/state of the CGRA (as per the resource monitor). It is relatively straightforward to simply schedule tasks in the queue in the order that the tasks are transmitted, but the actual scheduled order of the tasks (other than their transmission order) may be determined in a way that operates the CGRA efficiently; the order may be determined according to information included in the tasks. Accordingly, the scheduler may refer to data pointer, data size (area), and hardware size of the tasks.

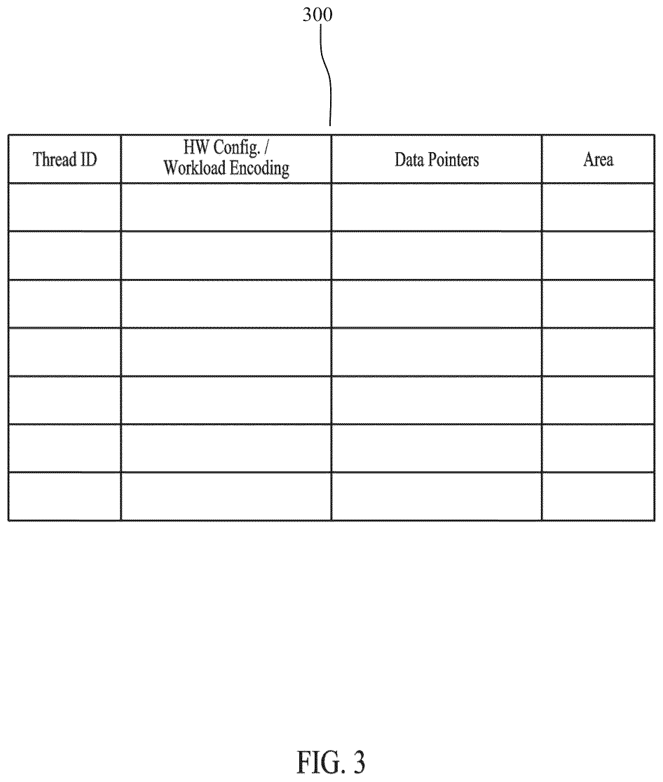

FIG. 3 illustrates an example of a queue 300 for recording a schedule, according to one or more embodiments.

A scheduler may sequentially record, in a queue, tasks to be processed by a CGRA. Information (fields) of the tasks may be recorded in the queue, as shown in FIG. 3. The information/fields of each task record/entry in the queue may include a thread identifier (ID), data pointers, and hardware configuration, described next.

The thread ID field of a queue record/entry of a task may include information identifying a processor and thread on which the task was generated.

The data pointers field of a queue record/entry of a task may specify locations of data that the task accesses. The data pointers may be used for prefetching data to speed up task execution.

The hardware configuration (or workload encoding) field of a queue record/entry of a task may include (i) a data size, which may be information about the amount of memory used by the task, and (ii) a hardware size, which may be information about the number of PEs used by the task.

The scheduler may find commonalities among the tasks, based on properties (fields) of tasks recorded in a task queue, and, the scheduler may determine an order in which the tasks are to be executed based on these commonalities.

To prevent execution of tasks from being deferred too long by the scheduler, the scheduler may also cause times at which the respective tasks are recorded into the queue. Specifically, the queue entries may include a field for recording the times. The times may be used as follows.

There may be an issue that an execution order of a particular task is continuously demoted by the scheduler (significantly delaying or preventing its execution). To solve this issue, the scheduler may, as noted above, record the time in which a task is recorded and may give processing priority to the task when the time information exceeds a predetermined limit so that the task may not be delayed for more than a predetermined time. To achieve such prioritization, for example, a processing order of the task may be changed so that the task is the first in the queue, or newer tasks may not be processed before the task.

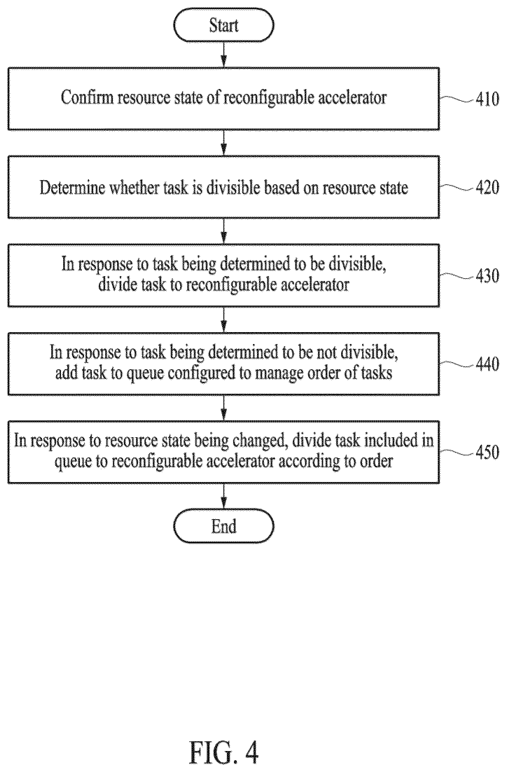

FIG. 4 illustrates an example of a scheduling method of a scheduler, according to one or more embodiments.

The scheduler may manage a task transmitted from a processor through operations 410 to 440, may analyze characteristics of the task, and may dispatch (immediately, or via a queue) the task to a reconfigurable accelerator. The reconfigurable accelerator may be a CGRA, for example.

In operation 410, the scheduler may confirm/determine a resource state of the reconfigurable accelerator through a resource monitor.

The resource monitor may repeatedly obtain information about availability of resources (i.e., resource state) from the reconfigurable accelerator at a predetermined time interval and may provide the obtained information to the scheduler. For example, the resource monitor may classify the resources by tracking which PEs are running, the frequency of data access in memory, and a current usage rate. Accordingly, at least a portion of the information obtained may be transmitted to the scheduler. The information about availability of resources may include quantitative information about available memory and processing hardware or may include information about whether each unit of memory and hardware is used/running. In short, the resource availability information may indicate which units/portions of hardware (e.g., PEs and memory) are available, and/or quantities of the same.

In operation 420, when the scheduler receives a task from a processor, the scheduler may determine whether the task is dispatchable based on the current or most recent resource state.

Sharing the reconfigurable accelerator by processors/cores may be provided through the scheduler. When an occurrence of the task is detected on one of the processors/cores (e.g., by an accelerator controller of a core), the task may be transmitted to the reconfigurable accelerator for accelerated processing thereby. The scheduler may manage a dispatch order of the transmitted task, based on the monitored resource states of the reconfigurable accelerator.

The task transmitted to the scheduler may have or be a loop pattern (or some construct that repeats on a processor). Loop processing speed may be increased by accelerating the loop detected in the processor (e.g., detected by an accelerator controller of a core) through the reconfigurable accelerator.

Whether the task is dispatchable may be determined by comparing memory and processing hardware size (e.g., a number of PEs) previously determined to be available in the reconfigurable accelerator, with data size and processing hardware size of the task.

In operation 430, in a case where the task is determined to be dispatchable, the scheduler may dispatch the task to the reconfigurable accelerator.

In a case where the task is immediately dispatched to the reconfigurable accelerator, the data and processing hardware size of the task may need to be smaller than available memory and processing hardware size/capacity of the reconfigurable accelerator.

To dispatch the task to the reconfigurable accelerator, the scheduler may instruct a core controller (e.g., an accelerator controller of a processor/core) to generate a bitstream to be transmitted to the reconfigurable accelerator. The bitstream may include settings-information required for the reconfigurable accelerator to execute the task.

When the bitstream is transmitted to the reconfigurable accelerator, the core controller may transmit a stall signal to its core to stop operation for the task, and the operation of the core may be stopped.

In operation 440, in a case where the task is determined to be not immediately dispatchable, the scheduler may add the task to a queue configured to manage an order of tasks queued to be executed by the reconfigurable accelerator; the task may later be dispatched from the queue. Determination of dispatchability is described next.

When, per the task's settings-information, either the hardware or memory of the task is larger than the available memory and hardware space/capacity of the reconfigurable accelerator (as per the monitored available resource state), the scheduler may determine that the task is not immediately dispatchable.

The scheduler may add tasks to be executed on the reconfigurable accelerator, such as a CGRA, based on a dispatch order (e.g., by managing a working queue of tasks).

An order in which the tasks are added may be determined to efficiently operate the reconfigurable accelerator based on settings-information included in the tasks (e.g., the bitstreamed tasks). To this end, the scheduler may refer to settings-information such as a data pointer, data size, and processing hardware size of the tasks.

Simply, the tasks transmitted to the scheduler may be added to the queue according, by default, to the order they are received, and other tasks may also be inserted into the remaining space while monitoring data and hardware utilization in real time. For example, during execution of the reconfigurable accelerator, when the hardware space needed by a queued task due to be executed next (at the head of the queue) is confirmed in the monitored hardware resource state, the time for a hardware reconfiguration in preparation for executing that task may be saved by reconfiguring the needed available hardware space to execute the next task, as described below.

Alternatively, a task may be added to have an order where it is the next task after a queued task that happens to include duplicate/overlapping data, as determined by referring to a data pointer recorded in the queue so that previously fetched data may be reused.

Alternatively, the task may be added to have an order in the queue where it is the next task after a task, in the queue, determined to have hardware that overlaps with the transmitted task being enqueued.

Even though the task is added to the queue, the processor may continue to compute until the task is arranged on the reconfigurable accelerator and the bitstream is generated. There may be a case in which a task that has been waiting in the queue for more than a predetermined time completes execution on the processor (e.g., a task that keeps getting “bumped” down the queue due to elevation of other tasks). The scheduler may receive a signal from the processor indicating that the loop of the task is complete and the scheduler may respond by removing the task from the queue.

Examples related to this are described in detail below.

In operation 450, in response to the resource state being changed, the scheduler may dispatch at least one task included in the queue to the reconfigurable accelerator according to the order of tasks in the queue.

The scheduler may detect the change in the resource state. This may be confirmed by receiving a signal according to a state change from the resource monitor or by confirming a change in resource information transmitted from the resource monitor at a predetermined time interval.

The scheduler may determine whether at least one task included in the queue is dispatchable based on the changed available resource state and the order recorded in the queue. For example, in some implementations, the scheduler may re-evaluate the entries in the queue every time the available resource state is updated. According to the changed resource state, the scheduler may determine that the memory and hardware may allow dispatching of the next task in the queue. The task may be dispatched based on determination results.

The scheduler may apply the techniques described herein to types of reconfigurable accelerators other than CGRAs, for example, when there is a controller for generating a hardware configuration in real time.

FIG. 5 illustrates an example of an operation of a scheduler 500, according to one or more embodiments.

In operation 501, a processor controller may detect a task performed on a processor. In operation 502, the processor controller may provide task information to the scheduler. For example, when a combination of repetitive instructions (e.g., a loop pattern) is detected in instructions to be executed by the processor, the processor controller may transmit task information (including the corresponding instructions) to the scheduler. The task information may include information such as ID, data pointer, data size, and hardware required for the task.

In operation 503, the scheduler may confirm an availability state of memory and processing hardware, based on current state information of a CGRA provided at a predetermined time interval from the resource monitor 508 of the CGRA. The scheduler may determine whether the transmitted task is immediately dispatchable based on monitored resource availability state of the CGRA. For example, the scheduler may dispatch the corresponding task according to whether there is available memory and processing hardware capacity of the CGRA sufficient for executing the task.

The scheduler may dispatch the corresponding task to the CGRA when there is sufficient capacity in the CGRA for the task to be divided. To this end, the scheduler may instruct the processor controller to generate a bitstream for the task in operation 504, and in operation 505, the processor controller may generate the bitstream for the task and may transmit the generated bitstream to the CGRA while simultaneously transmitting a stall command to stop the processing of the corresponding task on the processor.

When the task is determined to be not immediately dispatchable according to the recent monitored resource availability state of the CGRA, the task may be recorded into a queue for task scheduling in operation 506 (in practice, the queue may have entries of data about respective tasks, and bitstreamed code of tasks is stored separately and is pointed-to by the queue entries). Here, the scheduler may confirm a data pointer of the task to confirm data information and may determine priority to be recorded in the queue (for example, the queue may be implemented as a priority queue).

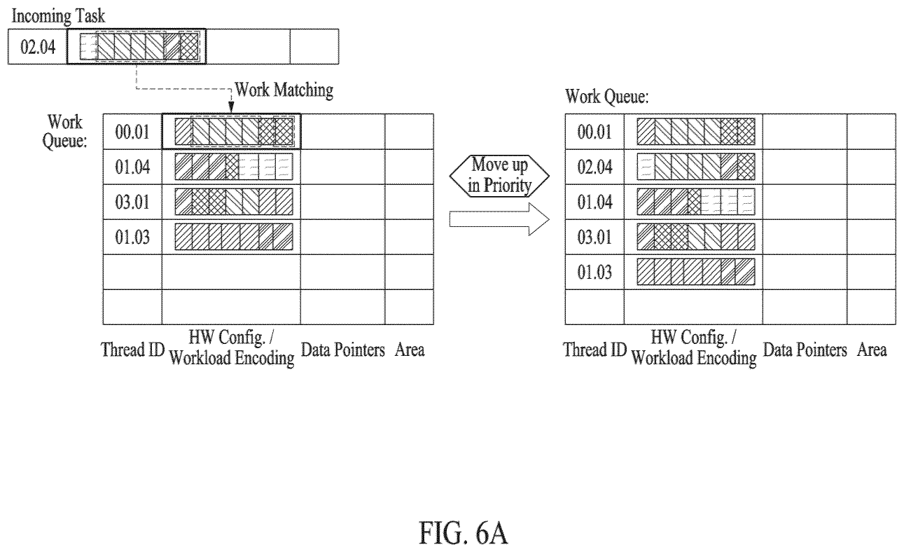

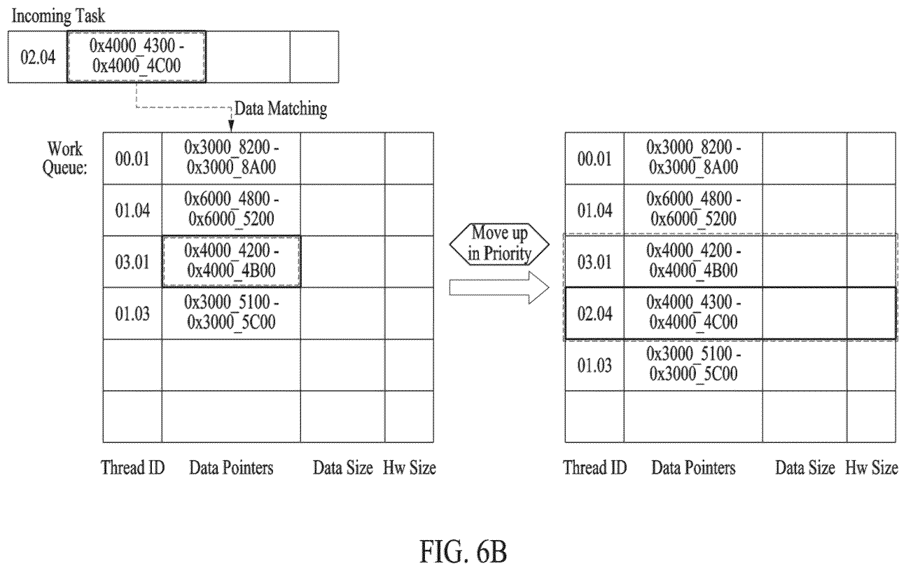

FIGS. 6A and 6B illustrate an example of a method of scheduling by matching tasks, according to one or more embodiments. The method may be performed by the scheduler 500 described above, for example.

FIG. 6A relates to a scheduling method based on hardware utilized by a task, and FIG. 6B relates to a scheduling method based on data of a task, according to one or more embodiments. In both figures, the Thread ID is in the form of processorID.threadID. In addition, the graphic patterns of the squares in the HW Config column represent different configuration attribute values.

According to FIG. 6A, when there is a task already in a queue that is utilizing duplicate hardware relative to a transmitted incoming task in the queue (the duplicity determined based on a hardware configuration specified in information of the transmitted task), the transmitted task may be adjusted to an order (e.g., next after the corresponding in-queue task) based on the order/position of the corresponding existing task. When assigning the incoming task to a CGRA, duplicate hardware in the same group may be reused. Referring to the example In FIG. 6A, when incoming task 02.04 is received, its hardware configuration attribute values are compared to hardware configuration attribute values of tasks in the work queue. The attribute values of the incoming task most closely match those of thread 00.01, and the incoming task 02.04 is positioned/ordered accordingly.

As shown by the example in FIG. 6B, when it is detected that an incoming task (e.g., thread ID 02.04) uses data that is duplicative of data of a corresponding task already in the work queue (e.g., thread ID 03.01), the incoming/transmitted task may be recorded in an order relative to the order/position of the corresponding task (e.g., right after the same) and the data may be reused when assigning the incoming task to the CGRA; since the incoming task (e.g. 02.04) is executed right after the corresponding task (e.g., 03.01), the data needed by the incoming task is presumably loaded and available. By reusing the data, communication with memory may be reduced, effectively reducing memory latency (from the perspective of the incoming task) and reducing overall bandwidth consumption.

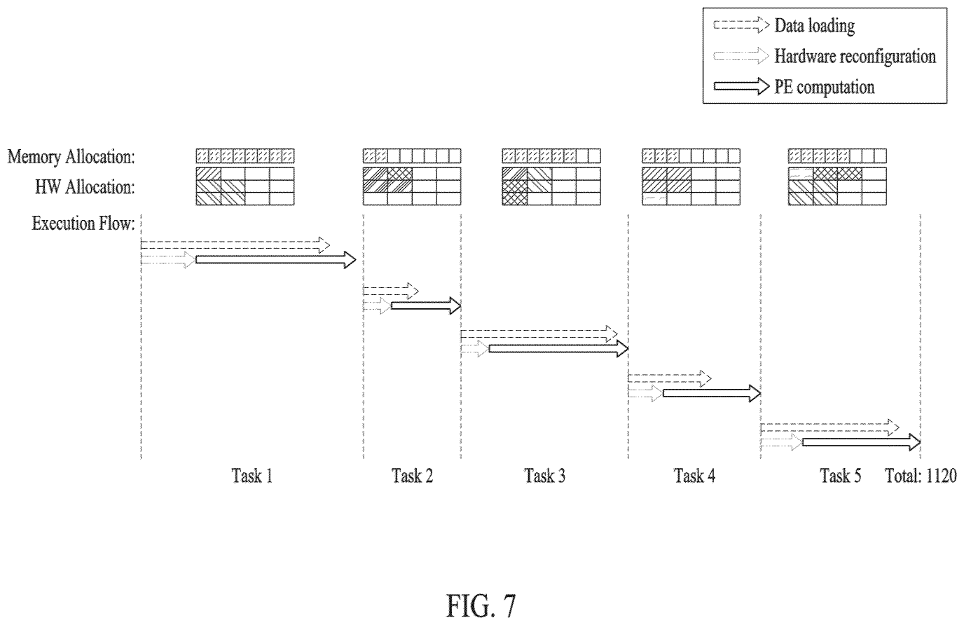

FIG. 7 illustrates an example of an operation of a CGRA by general FIFO scheduling, according to one or more embodiments. The operation may be performed by the scheduler 500 described above, for example.

As shown, a situation where tasks 1 to 5 are sequentially transmitted to a scheduler is assumed. This is an example where task 1 is transmitted and dispatched to a CGRA, and then tasks 2 to 5 are transmitted and recorded in a queue and processed sequentially in FIFO order. As indicated by the patterned arrows in each task-depiction, generally, execution of a task involves first loading data and performing hardware reconfiguration, the execution follows the hardware reconfiguration, and data loading may continue during execution.

The task 1, which is transmitted first, is a task that uses all memory (indicated by all 8 memory boxes being shaded) and ⅔ of hardware (indicated by corresponding shaded “HW Allocation” boxes). The first transmitted task 1 may be performed on an initially-empty CGRA (i.e., all resources are available). In the example of FIG. 7, the total execution time for the five tasks is 1120 time units.

As noted above, in the graph of FIG. 7, an upper arrow of a task-section represents an operation time for loading data into memory, and two arrows below the upper arrow represent a time for sequentially reconfiguring the hardware to process the corresponding task and a computation time for executing the corresponding task in the PE, respectively.

In a typical FIFO operation, one task may need to be finished before a next task is processed. The next task may not be configured or data may not be read until the currently executing task is finished.

This FIFO scheduling may result in significant under-utilization of hardware and memory resources (i.e., excess idle time), making it difficult to ensure utilization efficiency.

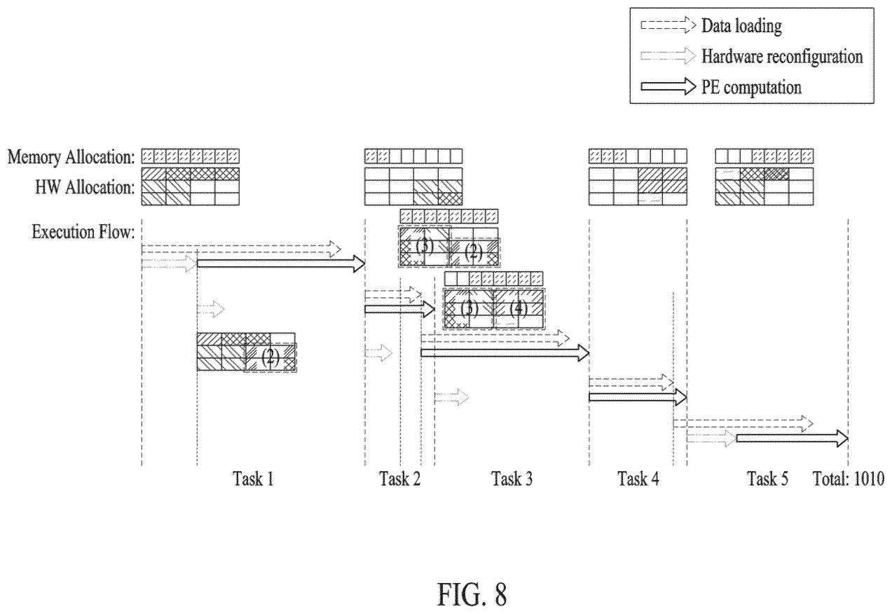

FIG. 8 illustrates an example of a method of using a resource for reconfiguration, according to one or more embodiments. The method may be performed by the scheduler 500 described above, for example.

Referring to FIG. 8, the general method of operating in a FIFO mode is the same as described above with reference to FIG. 7, however, the configuration of a next task may be read/implemented using hardware that is not being used for the execution of task 1 (thus increasing utilization of the otherwise-unused hardware). In this method, efficiency of a CGRA may be improved by utilizing unused resources.

Accordingly, since a reconfiguration for task 2 is complete by the time task 1 is finished, task 2 may be executed immediately on the pre-reconfigured hardware.

Since task 2 only uses ⅓ of the processing hardware during its execution, the remaining ⅔ may be used to prepare for the processing of task 3, which is to be executed as the “next” task, as described above. Any hardware not used during execution of task 2 may be used in reconfiguring processing hardware in anticipation of executing task 3.

When task 3 can begin being executed because task 2 is completed, task 3 may begin being executed immediately on the pre-reconfigured hardware.

Since task 3 uses 5/12 of the processing hardware, the remaining 7/12 of the hardware (known to be available per the above-described monitoring) may be used for task 4, which is next in order. Any processing hardware not used during execution of the task 4 may be reconfigured in anticipation of executing task 4.

In the same method, when executing a task, utilization of the CGRA may be improved by allocating a next task in the available processing hardware space.

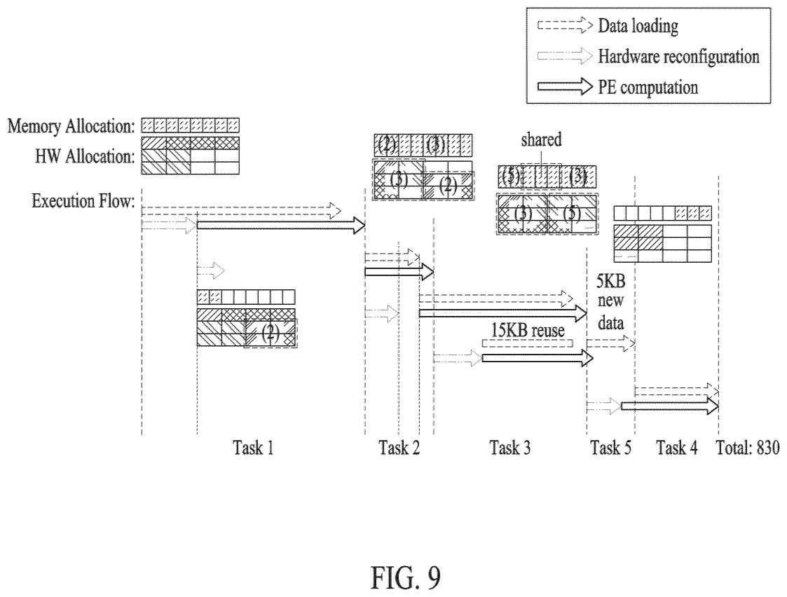

FIG. 9 illustrates an example of a method of executing a task having duplicate data, according to one or more embodiments. The method may be performed by the scheduler 500 described above, for example.

According to FIG. 9, since task 3 and task 5 have duplicate (overlapping/common) data, data may be reused (in-place in the accelerator) by changing the execution order of task 5 to be after task 3.

When executing task 5 beings execution (after task 3 has finished), the data loaded from task 3 may be reused and executed by task 5, thereby saving the time that would otherwise be required to reload the data for task 5.

In another example, when scheduling around tasks according to their having duplicate hardware, the priority/order of task 5, which has duplicate hardware with task 1, may be moved to a next order of task 1, thereby executing both tasks using the same hardware configuration. In this case, waste of resources for a hardware reconfiguration (i.e., the resources needed to perform the reconfiguration) may be reduced.

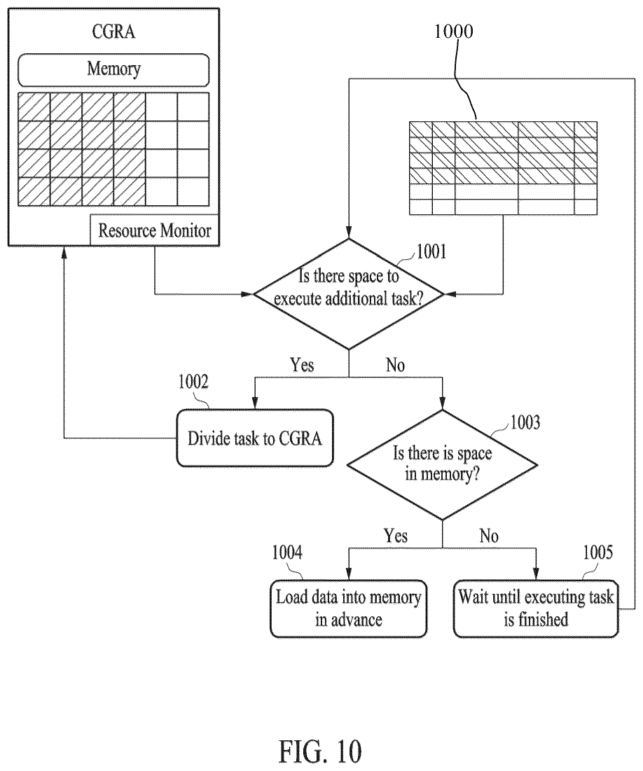

FIG. 10 illustrates an example of loading data using information of a queue 1000, according to one or more embodiments. The method may be performed by the scheduler 500 described above, for example.

A scheduler may confirm whether there is a space (available processing hardware capacity and available memory capacity) to execute additional tasks in a currently executing CGRA, in operation 1001.

When an additionally transmitted (incoming) task can be arranged in a free space of the currently executing CGRA, that is, when both data and hardware of the task can be additionally arranged in the CGRA, the task may be arranged in the CGRA, in operation 1002. In the CGRA, multiple tasks may be executed in parallel.

When there is not sufficient space to execute the additional tasks in the currently executing CGRA (not enough available memory or not enough available processing hardware), the scheduler may confirm whether there is a free space in memory, in operation 1003. When there is a free space in the memory, the data of the task may be loaded into the free memory in advance before execution of the task by referring to the data pointer recorded in the queue entry of the additionally transmitted task, in operation 1004.

When there is no free space in the memory, the currently executing task may be finished or the task may wait until a new task is executed, in operation 1005. At least a portion of operations 1001 to 1005 may be repeated by confirming again whether there is a space to execute the additional tasks, while another task is executed.

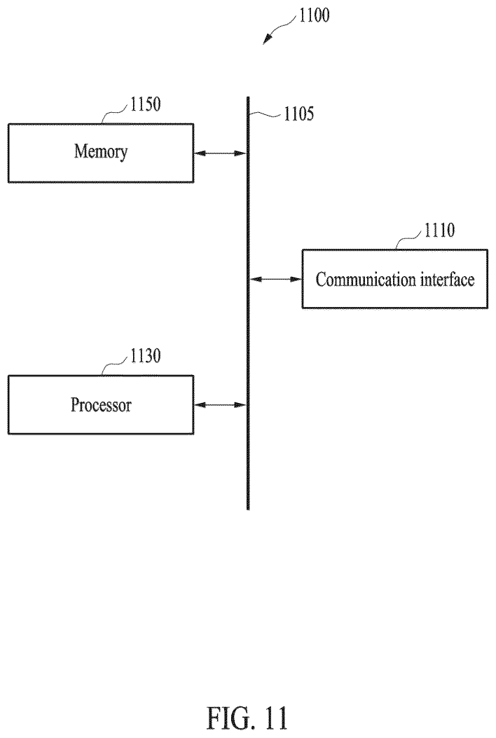

FIG. 11 illustrates an example of a scheduler, according to one or more embodiments.

Referring to FIG. 11, a scheduler 1100 may include a communication interface 1110, a processor 1130, and a memory 1150. The communication interface 1110, the processor 1130, and the memory 1150 may communicate with each other through a communication bus 1105.

The communication interface 1110 may receive a task from the processor 1130.

The processor 1130 may dispatch the task received through the communication interface 1110 to a CGRA or record the task in a queue.

The memory 1150 may store a variety of information generated in the processing process of the processor 1130 described above. In addition, the memory 1150 may store a variety of data and programs. The memory 1150 may include a volatile memory or a non-volatile memory. The memory 1150 may include a large-capacity storage medium such as a hard disk to store a variety of data.

In addition, the processor 1130 may perform at least one method described with reference to FIG. 2 to 10 or an algorithm corresponding to the at least one method. The processor 1130 may be a data processing device implemented by hardware including a circuit having a physical structure to perform desired operations. For example, the desired operations may include code or instructions in a program. The processor 1130 may be implemented as, for example, a central processing unit (CPU), a graphics processing unit (GPU), or a neural network processing unit (NPU). For example, a prediction apparatus 500 that is implemented as hardware may include, for example, a microprocessor, a CPU, a processor core, a multi-core processor, a multiprocessor, an application-specific integrated circuit (ASIC), and a field-programmable gate array (FPGA).

The processor 1102 may execute a program and control the scheduler 1100. The code of the program executed by the processor 1130 may be stored in the memory 1150.

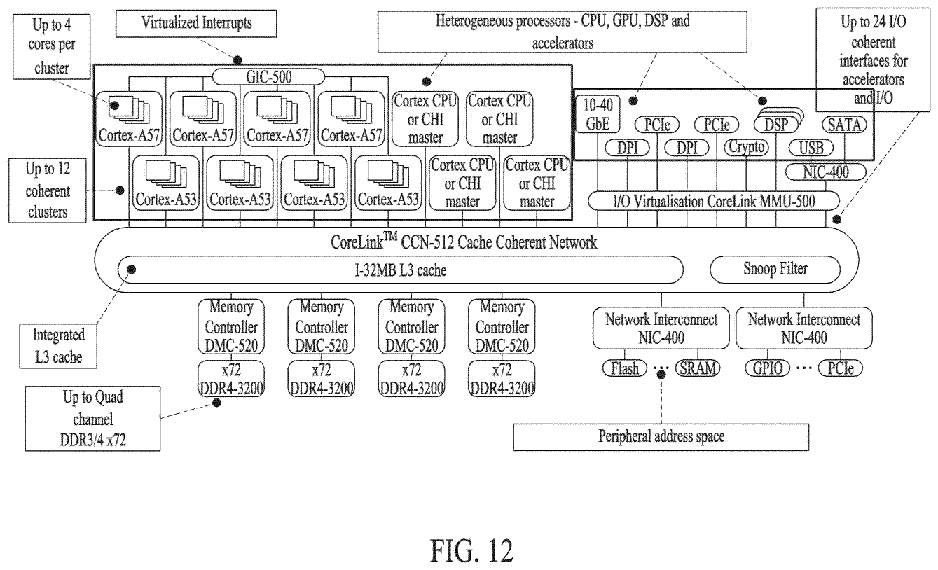

FIG. 12 illustrates an example of a platform for sharing an accelerator, according to one or more embodiments.

As shown, a platform where multiple cores share an accelerator such as a CGRA may be implemented as a server or a system on a chip (SoC) utilized in high performance computing (HPC).

The platform may have a structure in which multiple cores are connected to each other through an interconnection network and are connected to accelerators such as GPUs and digital signal processors (DSPs).

A connection structure of the CGRA according to an example may be operated in the same format as an accelerator such as a DSP of FIG. 12. The CGRA and the scheduler may be incorporated into a block in the same form as other accelerators such as DSPs and may communicate with cores through a chip network interconnect.

The computing apparatuses, the electronic devices, the processors, the memories, the accelerators, the information output system and hardware, the storage devices, and other apparatuses, devices, units, modules, and components described herein with respect to FIGS. 1-12 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-12 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of scheduling tasks performed by a scheduler, the method comprising:
monitoring a reconfigurable accelerator to determine a resource state of the reconfigurable accelerator;
in response to a first task being received from a processor among processors sharing the reconfigurable accelerator, determining that the first task is dispatchable for execution by the reconfigurable accelerator based on the resource state;
in response to a second task being received from any of the processors sharing the reconfigurable accelerator, determining that the second task is not dispatchable for execution by the reconfigurable accelerator based on the resource state;
based on the first task being determined to be dispatchable, dispatching the first task to the reconfigurable accelerator for execution thereby;
based on the second task being determined to be not dispatchable, adding the second task to a queue used to manage an order of tasks to be executed by the reconfigurable accelerator; and
based on a change in the resource state, according to the order, dispatching a task in the queue to the reconfigurable accelerator.

2. The method of claim 1, wherein
the monitoring comprises receiving an availability state of processing hardware and memory of the reconfigurable accelerator at predetermined time intervals.

3. The method of claim 1, wherein
the determining that the first task is dispatchable comprises comparing available memory and processing-hardware capacity of the reconfigurable accelerator with a data size and processing-hardware requirement of the first task.

4. The method of claim 1, wherein
the dispatching of the first task to the reconfigurable accelerator comprises:
instructing a processor controller to generate a bitstream to be transmitted to the reconfigurable accelerator; and
in response to the bitstream being transmitted to the reconfigurable accelerator, operation of the processor processing the task thereon is stopped.

5. The method of claim 1, wherein
the determining that the second task is not dispatchable is based on determining that either available memory of the reconfigurable processor does not satisfy a data size of the second task or that processing-hardware capacity of the reconfigurable accelerator does not satisfy a processing-hardware requirement of the second task.

6. The method of claim 1, wherein
the adding of the second task to the queue comprises:
determining that a third task represented in the queue has a data pointer corresponding to a data pointer of the second task, and based thereon adding the second task in a position of the queue that is set relative to a position of the third task in the queue.

7. The method of claim 1, wherein
the adding of the second task to the queue comprises:
determining that a third task represented in the queue has a hardware configuration that overlaps with a hardware configuration of the second task, and based thereon adding the second task in a position of the queue that is set relative to a position of the third task in the queue.

8. The method of claim 1, further comprising:
receiving, from the any of the processors, an execution completion signal corresponding to a third task; and
deleting the third task from the queue based on the execution completion signal.

9. The method of claim 1, further comprising:
during execution of the reconfigurable accelerator, based on an available processing-hardware capacity of the resource state space being confirmed, reconfiguring processing hardware of the reconfigurable accelerator to execute a next task in the queue according to the order.

10. The method of claim 1, further comprising:
dispatching a third task included in the queue to the reconfigurable accelerator according to the order and based on a change in the resource state.

11. The method of claim 1, wherein
the adding of the second task to the queue comprises:
in response to an age of the second task in the queue exceeding a threshold, adjusting processing priority of the second task in the queue.

12. The method of claim 1, wherein
the reconfigurable accelerator is a coarse-grained reconfigurable array (CGRA) accelerator.

13. A non-transitory computer-readable storage medium storing instructions that, when executed by a processor, cause the processor to perform the method of claim 1.

14. A scheduler comprising:
one or more processors; and
a memory storing instructions that when executed by the one or more processors cause the scheduler to:
monitor a reconfigurable accelerator to determine a resource state of the reconfigurable accelerator;
in response to a first task being received from a processor among processors sharing the reconfigurable accelerator, determine that the first task is dispatchable for execution by the reconfigurable accelerator based on the resource state;
in response to a second task being received from any of the processors sharing the reconfigurable accelerator, determine that the second task is not dispatchable for execution by the reconfigurable accelerator based on the resource state;
based on the first task being determined to be dispatchable, dispatch the first task to the reconfigurable accelerator;
based on the second task being determined to be not dispatchable, add the second task to a queue used to manage an order of tasks to be executed by the reconfigurable accelerator; and
based on a change in the resource state, according to the order, dispatch a task included in the queue to the reconfigurable accelerator.

15. The scheduler of claim 14, wherein
the monitoring comprises receiving an availability state of processing hardware and memory of the reconfigurable accelerator at predetermined time intervals.

16. The scheduler of claim 14, wherein
the determining that the first task is dispatchable comprises comparing available memory and processing-hardware capacity of the reconfigurable accelerator with a data size and processing-hardware requirement of the first task.

17. The scheduler of claim 14, wherein
the dispatching of the first task to the reconfigurable accelerator comprises:
instructing a processor controller to generate a bitstream to be transmitted to the reconfigurable accelerator; and
in response to the bitstream being transmitted to the reconfigurable accelerator, operation of the processor processing the task is stopped.

18. The scheduler of claim 16, wherein
the determining that the second task is not dispatchable is based on determining that either available memory of the reconfigurable processor does not satisfy a data size of the second task or that processing-hardware capacity of the reconfigurable accelerator does not satisfy a processing-hardware requirement of the second task.

19. The scheduler of claim 14, wherein
the adding of the second task to the queue comprises:
determining that a third task represented in the queue has a data pointer corresponding to a data pointer of the second task, and based thereon adding the second task in a position of the queue that is set relative to a position of the third task in the queue.

20. The scheduler of claim 14, wherein
the adding of the second task to the queue comprises:
determining that a third task represented in the queue has a hardware configuration that overlaps with a hardware configuration of the second task, and based thereon adding the second task in a position of the queue that is set relative to a position of the third task in the queue.

21. The scheduler of claim 14, wherein
the scheduler is configured to:
receive, from any of the processors, an execution completion signal corresponding to a third task; and
delete the third task from the queue based on the execution completion signal.

22. The scheduler of claim 14, wherein
during execution of the reconfigurable accelerator, based on an available processing-hardware capacity of the resource estate space being confirmed, reconfigure the processing hardware of the reconfigurable accelerator to execute a next task in the queue according to the order.

23. The scheduler of claim 14, wherein
dispatching a third task included in the queue to the reconfigurable accelerator according to the order is based on a change in the resource state.

24. The scheduler of claim 14, wherein
the adding of the second task to the queue comprises:
in response to an age of the second task in the queue exceeding a threshold, adjusting processing priority of the second task in the queue.

25. A method, comprising:
receiving, by an accelerator device, tasks executing on cores and transferred to the accelerator by the cores, wherein the cores analyze the tasks to select the tasks for transfer to the accelerator device, and each received task includes a task description specifying values of respective attributes of the task;
managing a first-in-first-out (FIFO) task queue by the accelerator device, the managing comprising receiving the tasks and adding entries to the task queue that respectively represent the received tasks and that include the respective task descriptions of the tasks, wherein each time a new entry for a new task and its task description are added to the queue:
it is determined whether at least a portion of the task description of the new task matches a corresponding portion of the task description of any entry in the task queue;
when it is determined that at least a portion of the task description of the new task matches a corresponding portion of the task description of any entry in the task queue, the new entry for the task is added at a position in the task queue that corresponds to the position in the task queue of the entry with the matching task description;
when it is determined that at least a portion of the task description of the new task does not match a corresponding portion of the task description of any entry in the task queue, the new entry for the task is added to the end of the task queue.

26. The method of claim 25, wherein each task description describes, about its corresponding task, a data size requirement of the corresponding task, a processing-hardware requirement of the corresponding task, and a location of data used by the corresponding task.

27. The method of claim 25, wherein the accelerator device has reconfigurable processing elements (PEs), and wherein each task description describes, about its corresponding task, a processing-hardware requirement of the corresponding task, and wherein while a first task is being executed by the accelerator device, based on monitoring a state of unallocated PEs of the accelerator device, and based on the processing-hardware requirement of a second task that is being dequeued from the task queue for execution by the accelerator device: configuring some of the unallocated PEs for use by the second task while the first task is executing and before the second task begins executing.
